(19) United States
(12) Patent Application Publication
(10) Pub. No.: US 2014/0124997 A1
(43) Pub. Date: May 8, 2014

(54) FOOD WORK TABLE

(71) Applicants: Kent Kangas, Bakersfield, CA (US); Michelle Kangas, Bakersfield, CA (US)

(72) Inventors: Kent Kangas, Bakersfield, CA (US); Michelle Kangas, Bakersfield, CA (US)

(21) Appl. No.: 13/669,959

(22) Filed: Nov. 6, 2012

(51) Int. Cl. A47J 47/00

(52) U.S. Cl. CPC A47J 47/00
USPC 269/54.5

(57) ABSTRACT

The present invention is a food work table that includes a plurality of cake sticks that are vertically upright and receive skewered food to hold in place, one or more planar durable plastic sheets that include a plurality of apertures that the cake sticks extend through and a plurality of dowels that elevate and stabilize the one or more planar durable plastic sheets in a horizontal upright position. The food work table also includes a base where the dowels perpendicularly extend from the base to elevate and stabilize the planar durable plastic sheet, a plurality of support feet that support the base and a cover that includes a top portion and 4 lower side portions, the cover protects the food work table.

### TECHNICAL FIELD & BACKGROUND

Cake pops are rounded balls of cake which have icing and are placed on a stick for a relatively quick and easy edible treat. When decorating a cake pop, it can be relatively difficult to keep the cake pop in place without the cake pop tipping over and leaning against other cake pops or food items making a big mess.

The present invention generally relates to a work table. More specifically, the invention is a food work table.

It is an object of the invention to provide a food work table that holds one or more food items in place to allow a user to decorate the one or more food items.

It is an object of the invention to provide a food work table that holds one or more food items in place to allow a user to display the one or more food items.

It is an object of the invention to provide a food work table that can be relatively easily washed and folded-up to conveniently store.

What is really needed is a food work table that holds one or more food items in place to allow a user to decorate the one or more food items that holds one or more food items in place to allow a user to display the one or more food items that can be relatively easily washed and folded-up to conveniently store.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a food work table, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

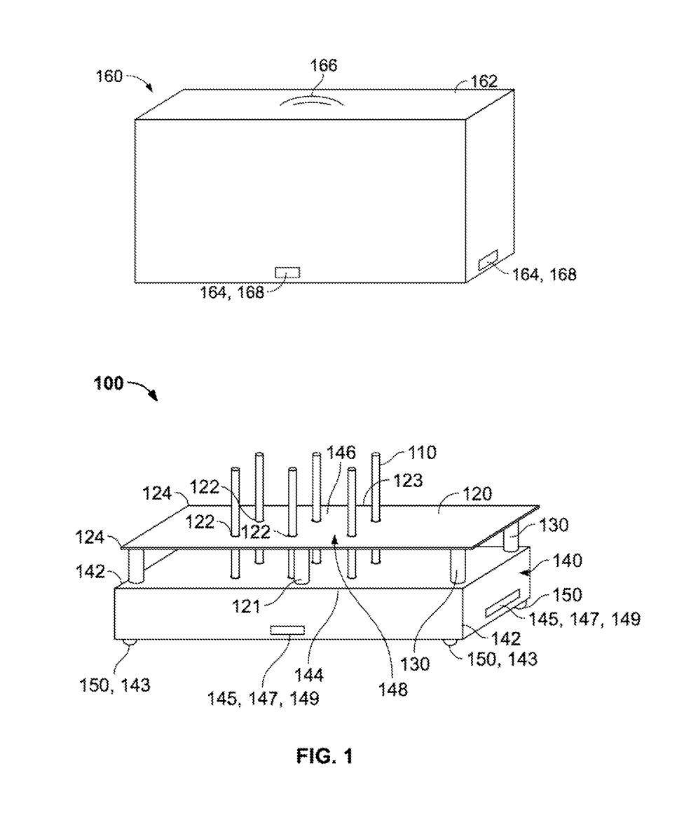

FIG. 1 illustrates a front view of a food work table 100, according to an embodiment of the present invention.

The food work table 100 includes a plurality of cake sticks 110, one or more planar PLEXIGLAS™ durable plastic sheets 120, a plurality of dowels 130, a base 140, a plurality of support feet 150 and a cover 160. The cake sticks 110 are vertically upright and can receive skewered food to hold in place. The cake sticks 110 can accommodate skewered food such as cakes, pies, pasties, baked goods or other suitable foods. FIG. 1 illustrates 6 cake sticks 110 however the food work table 100 can include any suitable number of cake sticks. The one or more planar durable plastic sheets 120 include a plurality of apertures 122 that the cake sticks 110 extend through. The one or more planar durable plastic sheets 120 serves as a surface that a user can work off of to prepare one or more foods to skewer onto the cake sticks 110. FIG. 1 illustrates 1 planar durable plastic sheet 120 although any suitable number of planar durable plastic sheets can be utilized by the food work table 100. The dowels 130 elevate and stabilize the one or more planar durable plastic sheets 120 in a horizontal upright position. FIG. 1 illustrates 6 dowels 130 that are positioned underneath each corner 124 of the one or more planar durable plastic sheets 120 and under a front middle edge 121 and a back middle edge 123 of the one or more planar durable plastic sheets 120. The dowels 130 are approximately 1-½ inches in height but can be any suitable height. The base 140 includes 4 top corners 142, a front middle edge 144, a back middle edge 146 and a middle portion 148 and the 6 dowels 130 that perpendicularly extend from the 4 top corners 142, the front middle edge 144 and the back middle edge 146 of the base 140 to elevate and stabilize the planar durable plastic sheet 120 in a horizontal upright position. The base 140 also includes the 6 dowels 130 that perpendicularly extend from the middle portion 148 of the base 140 and through the apertures 122 of the planar durable plastic sheet 120. The base 140 also has a generally rectangular shape 141 and is made of wood, plastic or other suitable material. The base 140 is approximately ¾ of an inch in height, 2 inches in width and 1 inch in length.

The support feet 150 support the base 140 and are disposed on 4 bottom corners 143 of the base 140. The support feet 150 also prevent the food work table 100 from moving and sliding while the food work table 100 is used. The support feet 150 are made of rubber or other suitable material. The cover 160 includes a top portion 162 and 4 lower side portions 164. The cover 160 includes a handle 166 disposed on the top portion 162 of the cover 160 to facilitate grasping and transporting the cover 140. The cover 160 protects the food work table 100. The cover 160 also includes a first plurality of indentations 168 disposed on the 4 lower side portions 164 of the cover 160 that correspond to a second plurality of indentions 145 disposed on a lower portion 147 of each side 149 of the base 140 to releasably secure the cover 160 to the base 140. The cover 160 is made of plastic or other suitable material.

The food work table is a flat top surface for making creative food or other projects. The food work table is made of a wood base with one or more PLEXIGLAS™ layers connected by a plurality of wooden dowels. The food work table is generally rectangular-shaped that provides a stable area for garnishing baked goods. The food work table is washable and may be placed in a freezer or a refrigerator to prep food to display later and can also be available in a rounded shape and smaller sizes. Caterers and pastry chefs are among the many people who may find the food work table both relatively convenient and simple to use. The food work table features a work table to decorate or present baked goods. The food work table is designed to be folded down for relatively effortless storage.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A food work table, comprising:
a plurality of cake sticks that are vertically upright and receive skewered food to hold in place;
one or more planar durable plastic sheets that include a plurality of apertures that the cake sticks extend through, the one or more planar durable plastic sheets serves as a surface that a user can work off to prepare the skewered food;
a plurality of dowels that elevate and stabilize the one or more planar durable plastic sheets in a horizontal upright position, the dowels are positioned underneath each corner of the one or more planar durable plastic sheets and under a front middle edge, and a back middle edge of the one or more planar durable plastic sheets;
a base that includes 4 top corners, a front middle edge, a back middle edge and a middle portion, the dowels perpendicularly extend from the 4 top corners, the front middle edge and the back middle edge of the base to elevate and stabilize the planar durable plastic sheet in a horizontal upright position and through the apertures of the planar durable plastic sheet;
a plurality of support feet that support the base, the support feet are disposed on 4 bottom corners of the base, the support feet prevent the food work table from moving and sliding while the food work table is used; and
a cover that includes a top portion and 4 lower side portions, the cover protects the food work table.

2. The food work table according to claim 1, wherein the skewered food includes a selected one or more of one or more cakes, one or more pies, one or more pasties and one or more baked goods.

3. The food work table according to claim 1, wherein the dowels are approximately 1-½ inches in height.

4. The food work table according to claim 1, wherein the dowels perpendicularly extend from the middle portion of the base.

5. The food work table according to claim 1, wherein the base has a generally rectangular shape.

6. The food work table according to claim 1, wherein the base is made of wood.

7. The food work table according to claim 1, wherein the base is made of plastic.

8. The food work table according to claim 1, wherein the support feet are made of rubber.

9. The food work table according to claim 1, wherein the cover includes a handle disposed on the top portion of the cover to facilitate grasping and transporting the cover.

10. The food work table according to claim 1, wherein the cover includes a first plurality of indentations disposed on the 4 lower side portions of the cover, the first indentations correspond to a second plurality of indentions disposed on a lower portion of each side of the base to releasably secure the cover to the base.

11. The food work table according to claim 1, wherein the cover is made of plastic.

12. A food work table, comprising:
a plurality of cake sticks that are vertically upright and receive skewered food to hold in place;
one or more planar durable plastic sheets that include a plurality of apertures that the cake sticks extend through, the one or more planar durable plastic sheets serves as a surface that a user can work off to prepare the skewered food, the skewered food includes a selected one or more of one or more cakes, one or more pies, one or more pasties and one or more baked goods;
a plurality of dowels that elevate and stabilize the one or more planar durable plastic sheets in a horizontal upright position, the dowels are positioned underneath each corner of the one or more planar durable plastic sheets and under a front middle edge, and a back middle edge of the one or more planar durable plastic sheets, the dowels perpendicularly extend from the middle portion of the base;
a base that includes 4 top corners, a front middle edge, a back middle edge and a middle portion, the dowels perpendicularly extend from the 4 top corners, the front middle edge and the back middle edge of the base to elevate and stabilize the planar durable plastic sheet in a horizontal upright position and through the apertures of the planar durable plastic sheet;
a plurality of rubber support feet that support the base, the support feet are disposed on 4 bottom corners of the base, the support feet prevent the food work table from moving and sliding while the food work table is used; and
a cover that includes a top portion and 4 lower side portions, the cover protects the food work table, the cover includes a handle disposed on the top portion of the cover to facilitate grasping and transporting the cover.

13. The food work table according to claim 12, wherein the cake sticks includes 6 cake sticks.

14. The food work table according to claim 12, wherein the dowels are approximately 1-½ inches in height.

15. The food work table according to claim 12, wherein the dowels include 6 dowels.

16. The food work table according to claim 12, wherein the base has a generally rectangular shape.

17. The food work table according to claim 12, wherein the base is made of wood.

18. The food work table according to claim 12, wherein the base is made of plastic.

19. The food work table according to claim 12, wherein the base is approximately ¾ of an inch in height, 2 inches in width and 1 inch in length.

20. The food work table according to claim 12, wherein the cover is made of plastic.
